(19) United States
(12) Patent Application Publication
(10) Pub. No.: US 2003/0177200 A1
(43) Pub. Date: Sep. 18, 2003

(54) Drag and drop web self-publishing system

(76) Inventors: Brian D. Laughlin, Wichita, KS (US); Mark R. Elliott, Wichita, KS (US)

Correspondence Address: Mark L. Lorbiecki, Esq., BLACK LOWE & GRAHAM PLLC, 816 Second Avenue, Seattle, WA, 98104, US

(21) Appl. No.: 10/096,813

(22) Filed: Mar. 12, 2002

(51) Int. Cl. G06F 15/16

(52) U.S. Cl. 709/218; 709/202

(57) ABSTRACT

A system and method are provided for publishing data on a network. A user directs a web browsing software program to a first address on the network and retrieves the data located there. Upon retrieving the data located at the first address, the browser invokes a COM object program associated with the data. The COM object has identified a second set of data located at a second address stored in association with the first address on the network. Once the second set of data is located, the COM object translates the second set of data to a format interpretable by the web browsing software program; and then displays the formatted second set of data.

### FIELD OF THE INVENTION

This invention relates generally to software products and, more specifically, to software to facilitate collaborative editing.

### BACKGROUND OF THE INVENTION

The Internet or the World Wide Web (“the web”) has become a convenient and inexpensive resource for finding information about nearly every subject imaginable. Widespread availability of computer programs called web browser software and multiple, available, and easy means of connection have fueled tremendous growth in use of the web. A web browser is a client-side program for establishing communications between a client computer and a server computer on the web (i.e., a web server), and for interpreting data sent to the client computer. The software will then read the data sent and display it for viewing on the client computer monitor.

The Internet, which is a global web of interconnected computers and computer networks, integrates local area networks (LANs) located in various entities, such as businesses, libraries, federal agencies, institutes of learning, and research organizations into a single communication network. The Internet uses a common communication protocol suite, known as a Transmission Control Protocol/Internet Protocol (TCP/IP), which was specifically designed for the interconnection of different computer systems. Internal and external networks are linked by routers that route data packets from a sending network to another router or a receiving network. Gateways handle data transfer and conversion of messages from a sending network to the protocols used by a receiving network. Typically, gateways refer to devices that translate between applications. For example, e-mail gateways translate messages from one vendor's messaging program to another vendor's messaging program so that users with different e-mail programs can share messages over a network.

The Internet uses a message standard, known as a Simple Mail Transfer Protocol (SMTP), which works in conjunction with a user's e-mail program and defines the control messages used by two computers to exchange e-mail messages. Such controls include verification of proper connection, identification of sender, negotiation of transmission parameters, and message transmission. SMTP is responsible for 1) sending mail created by a local user to another computer and 2) receiving mail from other computers on the network and transferring it to the local user's e-mail program.

In a typical transaction, a web browser transmits a request to download a document. Often that data is a discrete package of data termed a document and sent to the client computer by means of hypertext transfer protocol (HTTP). HTTP is an application-level and standardized protocol with the lightness and speed necessary for distributed, collaborative, information systems. It is the language of the web. It is a generic, stateless, object-oriented protocol that can be used for many tasks, such as name servers and distributed object management systems, through extension of its request methods (commands). A feature of HTTP is the typing and negotiation of data representation, allowing systems to be built independently of the data being transferred.

To request data from the web, the browser will direct the server to an address called a uniform resource locator (URL). The download request is routed through the web until it reaches a web server indicated by the URL. The web server responds to the request by transmitting the indicated document, commonly called a “web page,” back to the client computer. Such is the infrastructure of network communication either in local networks or on the world-wide web.

The infrastructure described above facilitates the communication between the several client computers and the network server. As the computers can communicate, they require a uniform lexicon. That lexicon is called a “markup language” and refers to the standardized annotations embedded in data packets to insure that browsers will display the data. Standard Generalized Markup Language (“SGML”) is one such markup language with hypertext capability, i.e. the ability to link explanatory content such as text, pictures, or diagrams to points in a body of text. SGML is defined formally as “a language for document representation that formalizes markup and frees it of system and processing dependencies.” SGML is a language for describing the structure of documents and for describing a tagging scheme to delineate that structure within text.

For creating hypertext content, Web documents utilize a subset of SGML called Hypertext Markup Language (“HTML”). An HTML textual document can be thought of as plain text that contains formatting annotations or instructions in the form of HTML markup codes or “tags.” Tags tell Web browsers how to render and print documents, and are also used to specify hyperlinks.

Hypertext usage is not limited to the Internet. Various multimedia applications utilize hypertext to allow users to navigate through different pieces of information content. For instance, an encyclopedia program might use hyperlinks to provide cross-references to related articles within an electronic encyclopedia. The same program might also use hyperlinks to specify remote information resources such as Web documents located on different computers.

Web pages are usually written using the hypertext mark up language (HTML) and often include links to other objects. For example, a web page may include links to one or more graphics objects that are to be downloaded and displayed with the web page. A web page may also include links to program code (e.g., a Java applet) that is to be downloaded and executed on the client computer when the web page is displayed. The downloaded code may be used to create a more interactive presentation, for example, by animating portions of the web page or by prompting for, and collecting user input. COM objects, as discussed below are an example of such downloaded code. A web page may also include pointers to plug-in modules that are expected to be resident in the client computer. Such program modules are commonly referred to as “plug-ins” and are generally used to extend the capabilities of the web browser. For example, a plug-in may be invoked to generate audio output, perform file translation and so forth.

HTML is an arcane language in that it is neither intuitive nor are documents in their HTML state easy to read or to interpret. Constructing an HTML document requires software that will interpret and manipulate the tags to present the information in a manner that will be interpreted as meaningful. Software directed to this interpretation and manipulation of the HTML is generally, itself, specialized and difficult to learn. In most organizations or enterprises, one or several persons are dedicated to the construction and maintenance of the enterprise's data offered at the enterprise's URL sites. The task of construction HTML documents is difficult for those unschooled in the use of such software.

Because very fast computers are commonly available, transfer of the document across a network is often the rate-determining step in presenting a web page for viewing on browsing software. Because data transfer in a network is generally slower than the recall of data from internal memory. To speed the display of information on the world-wide web, where the same data is often drawn from the same site for repeated viewing, the browser will store that data on local memory rather than drawing the same data through the network from the URL. Occasionally, as well, a computer user may wish to capture a web page for a later recall or to forward to another user.

In many web browsers, client computers capture data by saving a copy of the underlying HTML document, including its links to graphics images, downloaded code, plug-ins and so forth. When the HTML document is recalled from storage, the web browser, in order to regenerate the displayed web page, reinterprets the HTML. Assuming that the downloaded code, graphics images and plug-ins are available, the web page may be redisplayed with its original graphical and dynamic characteristics. If any of the files or code is not available, the HTML page is not fully or properly displayed. Any changes made in stored HTML pages on the web, require complete updating of pages in light of the resources stored there. Webmasters must not only construct pages, but must maintain them as well for optimum effect of the stored data.

In light of these shortcomings of HTML construction and data transfer, document sharing via the web is cumbersome. Webmasters must act as middlemen to construct documents on the web. The webmaster's intervention results in delaying communication, which, in turn, slows the business process. Often, by the time the information can be published by the webmaster, data placed on the web is often out of date. Other times, collaborating authors will not be able to contribute until the data becomes available. Iteration in the collaborative process loses more and more time to the non-productive process of formatting and storing data on the web.

In the course of this collaboration process, webmasters place documents on the network for review and collaboration at distinct addresses. A collaborator might easily confuse earlier data stored at these distinct addresses for the most recent version of the data. Old data might direct browsers to addresses where no data is now stored. “Link rot” describes the gradual loss of data at URL's linked to documents. The converse situation exists as well where many artifacts of prior iterations remain on the web. These artifacts clutter the storage facility of the network.

Where an application generates data files the data files are generally recognizable by means of a header embedded in the file. The embedded header allows a computer software product to recognize the data by virtue of its Multi-Purpose Internet Mail Extensions (“MIME”) type. MIME is an extension of the original Internet e-mail protocol that lets people use the protocol to exchange different kinds of data files on the Internet: audio, video, images, application programs, and other kinds, as well as the ASCII handled in the original protocol, the Simple Mail Transport Protocol (SMTP).

As can readily be appreciated, there is an unmet need for a method and system for recognizing, formatting, and storing data on a network without requiring the intermediate intervention of and publication by the webmaster. The need exists to allow authors to self-publish files directly to the network without any knowledge of web programming. Additionally the need exists to catalogue existing data on the network and to display it in a manner that accurately reflects the data stored there.

### SUMMARY OF THE INVENTION

A system and method are provided for dynamically creating a web page based upon the content of a directory on a network, making that content available to browsing software. The web page includes dynamic links to the content of the directory for display and manipulation by extant software programs according to the MIME attributes of the data.

The system allows the generation of web pages by the simple action of moving files into a designated directory. The invention generates the web page by reading data in the designated directory and then creating links to the data. It does this by means of embedded information known as MIME types, i.e. Multi-Purpose Internet Mail Extensions. MIME types allow the invention to identify the nature of the data contained in the file and to select such applications as might be necessary to either view or to manipulate that data. Using the browser to activate the created link will either invoke the viewers attached to the browser as plug-ins or invoke the application programs through the use of the MIME attributes of the files. The invention provides dynamic web page drafting based on the content of a designated directory. Computers executing software encode the content relieving the user from that task.

One use of the system is to facilitate the collaboration between several clients on a network. The system allows the publication of works on the network without the previously necessary step of having a webmaster place data in a viewable format on the network as a website. The invention allows the immediate presentation of the data simply by placing that data in the designated directory. In accordance with other aspects of the invention, removing data from the designated directory will remove it from the web page. The resulting web page is defined by the then current content of the designate directory.

The invention provides a system and method for publishing data on a network. A user directs web browsing software program to a first address on the network and retrieves the data located there. Upon retrieving the data located at the first address, the browser invokes a COM object program associated with the data. The COM object identifies a second set of data located at a second address stored in association with the first address on the network. Once the second set of data is located, the COM object translates the second set of data to a format interpretable by the web browsing software program and then displays the formatted second set of data.

### BRIEF DESCRIPTION OF THE DRAWINGS

The preferred and alternative embodiments of the present invention are described in detail below with reference to the following drawings.

FIG. 1 shows an exemplary network for hosting the invention;

FIG. 2 shows an exemplary client computer on the network displayed in FIG. 1;

FIG. 3 shows a screen shot of a desktop display and an e-mail document on a client computer having a graphic user interface;

FIG. 4 shows a screen shot of a splash page used to initiate the invention;

FIG. 5 shows a screen shot of the log-in page and the information necessary in one embodiment of that page;

FIG. 6 is a comparative graphic displaying both a directory structure and a dynamically drawn Web page portraying that directory structure;

FIG. 7 is a screen shot portraying the launch of an application invoked by the browser;

FIG. 8 is a comparative graphic displaying both a directory structure and a dynamically drawn Web page indicative of a process of archiving files; and,

FIG. 9 is a flow chart of the inventive process described herein.

### DETAILED DESCRIPTION OF THE INVENTION

The following discussion is intended to provide a general description of a suitable computing environment in which the invention may be implemented. While the invention will be described in the general context of an application program that runs on an operating system in conjunction with a personal computer and in connection with a server, those skilled in the art will recognize that the invention also may be implemented in combination with other program modules. Generally, program modules include routines, operating systems, application programs, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like.

The invention may also be practiced in distributed computing environments where tasks are performed by remote processing devices that are linked through a communications network. In a distributed computing environment, program modules may be located in both local and remote memory storage devices. Execution of the program modules may occur locally in a stand-alone manner or remotely in a client/server manner. Examples of such distributed computing environments include local area networks of an office, enterprise-wide computer networks, and the Internet.

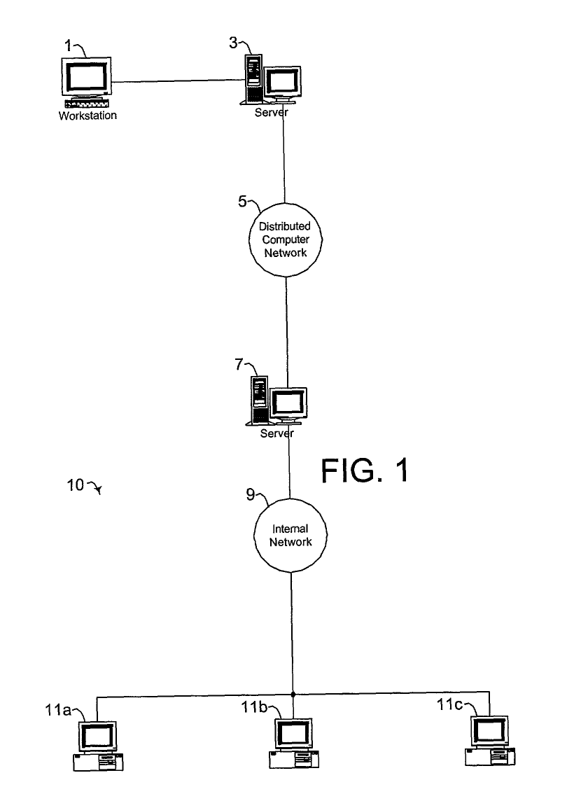

FIG. 1 illustrates a typical client-server environment 10 in which an exemplary embodiment of the present invention operates. A computer system or client 1, such as a conventional personal computer or any device operable to communicate over a network, is connected to an Internet server computer 3 (“server”). The server 3 is generally provided by an Internet service provider (ISP), which provides Internet access for a typical Internet user. The server 3 is connected to a distributed computer network 5, such as the Internet or a wide-area network (“WAN”), and enables the client 1 to communicate via the distributed computer network 5.

The client 1 communicates via the combination of the server 3 and the distributed computer network 5 to a server 7, such as a communication or an e-mail server. In an exemplary embodiment, servers 3 and 7 support e-mail services, contain a message store for holding messages until delivery, and contain a translation facility or gateway for allowing users having different e-mail programs to exchange mail. The server 7 is connected to an internal network 9, such as a local-area network (“LAN”) and enables the client 1 to communicate with the clients 11a, 11b, and 11c via the internal network 9.

The clients 11a, 11b, and 11c are not only able to respond to a communication from the client 1, but are also able to initiate communication with the client 1. The clients 11a, 11b, and 11c can send information via the internal network 9 to the server 7. The server 7, in turn, forwards the information to the client 1 via the distributed computer network 5. The information is retrieved by the server 3 and can be forwarded to the client 1, when requested by the client 1.

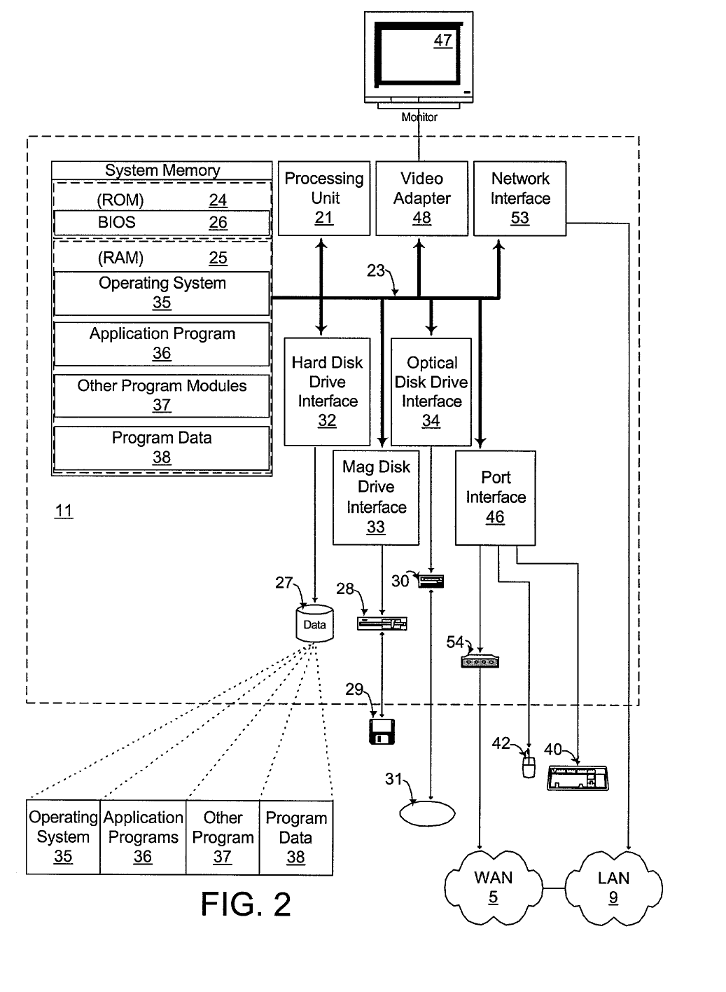

With reference to FIG. 2, an exemplary system for implementing the invention includes a conventional personal computer 11, which serves as a client. The client 11 may represent any or all of the clients 1, 11a, 11b, and 11c illustrated in FIG. 1. The client 11 includes a processing unit 21, a system memory 22, and a system bus 23 that couples the system memory to the processing unit 21. The system memory 22 includes read only memory (ROM) 24 and random access memory (RAM) 25. A basic input/output system 26 (BIOS), containing the basic routines that help to transfer information between elements within the client 11, such as during START-up, is stored in ROM 24. The client 11 further includes a hard disk drive 27, a magnetic disk drive 28, e.g., to read from or write to a removable disk 29, and an optical disk drive 30, e.g., for reading a CD-ROM disk 31 or to read from or write to other media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer-readable media provide nonvolatile storage for the client 11. Although the description of computer-readable media above refers to a hard disk, a removable magnetic disk and a CD-ROM disk, it should be appreciated by those skilled in the art that other types of media which are readable by a computer, such as magnetic cassettes, flash memory cards, digital video disks, Bernoulli cartridges, and the like, may also be used in the exemplary operating environment.

A number of program modules may be stored in the drives and RAM 25, including an operating system 35, one or more application programs, such as an e-mail program module 36, other program modules, such as a message manager program module 37, a local message store 38, and a database 39 for supporting e-mail applications. A user may enter commands and information into the client 11 through a keyboard 40 and pointing device, such as a mouse 42. Other input devices (not shown) may include a pen, touch-operated device, microphone, joystick, game pad, satellite dish, scanner, or the like. These and other input devices are often connected to the processing unit 21 through a port interface 46 that is coupled to the system bus, but may be connected by other interfaces, such as a serial port, game port or a universal serial bus (USB). A monitor 47 or other type of display device is also connected to the system bus 23 via an interface, such as a video adapter 48. In addition to the monitor, personal computers typically include other peripheral output devices (not shown), such as speakers or printers.

The client 11 operates typically in a networked environment using logical connections to one or more remote computers, such as a remote computer 49. The remote computer 49 may be an e-mail server (which includes one or more message stores), as described above in connection with FIG. 1, a file server (which includes one or more file stores), a router, a peer device or other common network node, and typically includes many or all of the elements described relative to the client 11. The logical connections depicted in FIG. 2 include the local area network (LAN) or the wide area network (WAN) 5. Such networking environments are commonplace in offices, enterprise-wide computer networks, intranets and the Internet.

When used in a LAN networking environment, the client 11 is connected to the LAN 9 through a network interface 53 or additionally through the WAN 5. When used in a WAN networking environment, the client 11 typically includes a modem 54 or other means for establishing communications over the WAN 5, such as the Internet. The modem 54, which may be internal or external, is connected to the system bus 23 via the serial port interface 46. In a networked environment, program modules depicted relative to the client 11, or portions thereof, may be stored in the remote memory storage device. It will be appreciated that the network connections shown are exemplary and other means of establishing a communications link between the computers may be used.

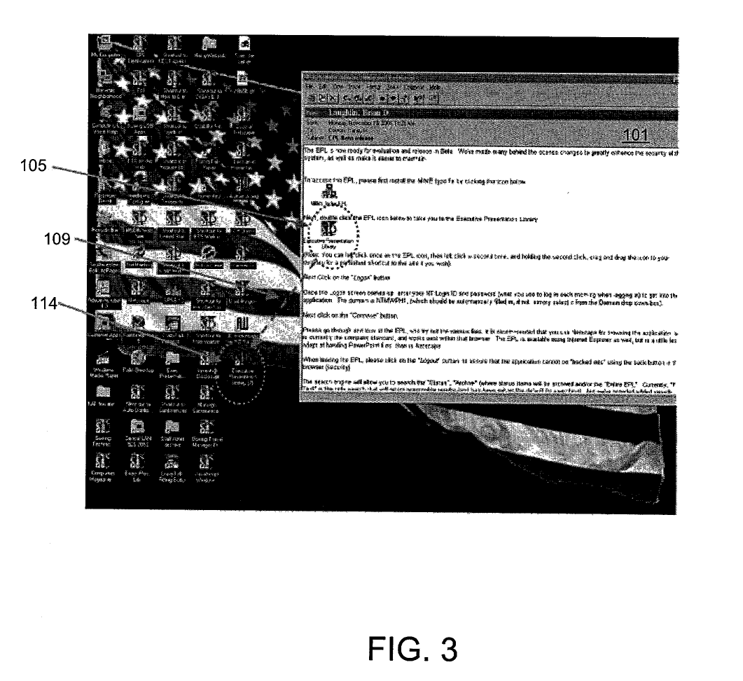

Referring now to FIGS. 1-3, the invention allows any of several clients 1, 11a, 11b, or 11c connected to the LAN 5 either directly or through the WAN 9, to facilitate the collaboration among the several clients, 1, 11a, 11b, or 11c. The originator from their client computer 11a, e-mails a link to an application 105 to their collaborators 1, 11b, and 11c. The application 105 itself remains on the server 7. The e-mailed link contains the address to where the application 105 resides on the server 7. An exemplary e-mail 101 is shown in FIG. 3. From within the e-mail 101, the recipient drags, as shown by an arrow 109, the attached link to the application 105 to the desktop 114. This action installs a link to the application 105 on the recipient's computer, 1, 11b, or 11c.

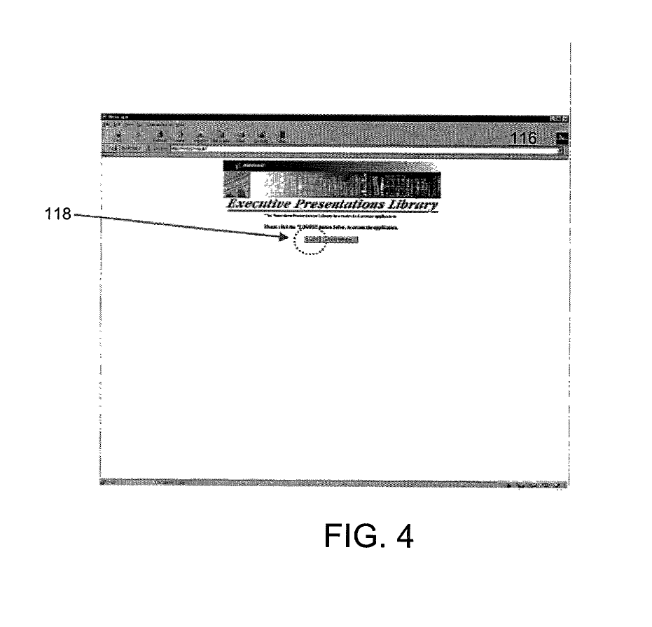

Referring now to FIGS. 1-4, once so installed, the link enables the collaborator to immediately connect to the application 105 as it resides on the server 7. When the collaborator clicks on the link, that click enables the collaborator's web page browser and directs the same to the location of the application 105 on the server 7. The application 105 opens as a web-site splash page 116 portrayed in FIG. 4 and shown by way of non-limiting example. The splash page 116 allows a collaborator to initiate a log-on process by means appropriate to the browser, generally by means of a Graphic User Interface (“GUI”) through a process known as “clicking on” a graphic object which action initiates the execution of the program. As is well-known “clicking on” refers to moving a screen pointer to a graphic point of a screen and there activating a button on a mouse. The clicking on a point within a page displayed by the browser might also activate a link that causes the browser to display a page located at a distinct URL. In this case, by way of non-limiting example, clicking on an object 118 initiates a log-in process.

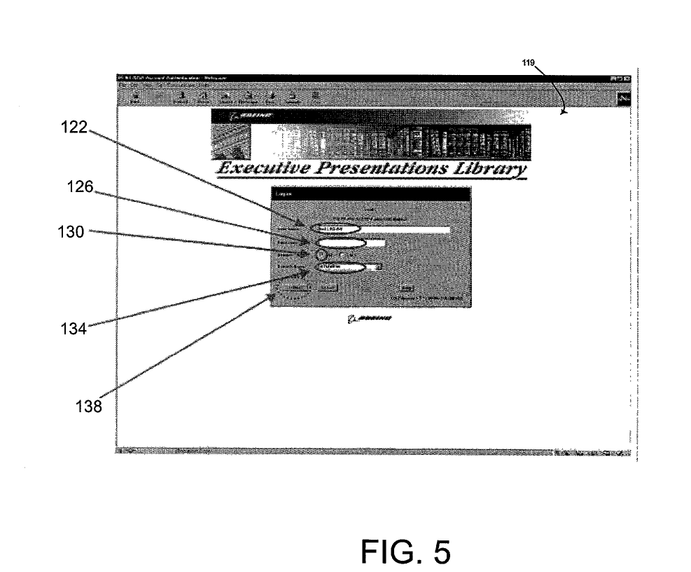

FIG. 5 displays a log-in screen 119. In a preferred embodiment, the log-in screen 119 is generated as an Active Server Page or “ASP”; in another preferred embodiment the log-in screen 119 conveys the log-in information to a remotely located component object model (“COM”) object. In either regard, the successful log-in will initiate the action of a COM object as discussed below.

As is known, an Active Server Page (ASP) is suitably an uncompiled program that includes one or more sets of code that are processed on a server before the page is sent to the user. As is also known, an ASP is a feature of the Microsoft Internet Information Server (IIS). But, because the server-side script is just building a regular HTML page on the server then feeding it to the web browser, the resulting display can be delivered to almost any browser. While use of an ASP is a presently preferred method, the functionality of a page might be accomplished by including a script written in VBScript or JScript in an HTML file or by using ActiveX Data Objects (“ADOs”) program statements in the HTML file.

A presently preferred embodiment includes use of the server-side ASP rather than a client-side script, where either might work, because the server-side script will result in an easily displayable HTML page. It will be appreciated that client-side scripts (for example, with JavaScript) may not work as intended on older browsers or may result in performance degradation for loading the page. Sever-side script allows for greater control of variables in hardware or resident software that might otherwise affect the display of data stored on the network.

The log-in screen 119 facilitates both security and selection of displayed content according to the identity of the user. Logging-in includes entering a user name 122 and a password 126. This information is used in a preferred embodiment to establish the identity of the user and thus to accord to the user security privileges and to tailor functionality of the ASP and invoked COM object to those functions appropriate to the particular user. While not exhaustive, a list of functions, dependant upon the identity of a user, includes without limitation: allowing the user to make changes to documents while reviewing; defining a subset of documents accessible to a particular user; or directing a user to only those documents the user finds relevant results from identifying the user. The use of the log-in screen 119 is not a necessary feature of the invention but is included to teach one embodiment of the invention.

FIG. 5 shows further refinements that exist in a presently preferred embodiment. Not all networks are homogenous; they might include distinct operating systems. In environments or networks where several machines with distinct operating systems exists, the displayed log-in screen allows an opportunity to choose a domain 130 where files are readable by a particular operating system. In a preferred embodiment of the invention, the selection of an operating system, or node 130 might dictate the file location available to the user, as would the user's identity. The user in a login object 134 selects file location. When the information is fully entered, the user clicks on the continue object to proceed. In this embodiment, the COM object checks the variables against a look-up table defining security privileges and responds accordingly. However it would be understood by those skilled in the art that the validation of identity and/or privileges could be performed in other ways.

When the COM object responds by granting appropriate security privileges, it next instantiates another COM object, which, in turn, reads the contents of an appropriate folder structure, and generates a series of hyperlinks to the files located within that folder. Each of the individual hyperlinks link to the files of the same name within the folder that was read. When a generated hyperlink is “clicked on” by the user, another COM object is instantiated, which does a binary read of the chosen file, along with the MIME type of the file, and converts the information into http format. The HTTP-formatted information then launches the appropriate browser “plug-in,” which then correctly displays the selected file to the user. As is known, a COM is an object-based programming model designed to promote software interoperability, i.e. to allow two or more applications or “components” to easily cooperate with one another, even if they were written by different vendors at different times, in different programming languages, or if they are running on different machines running different operating systems. To support its interoperability features, COM defines and implements mechanisms that allow applications to connect to each other as software objects. A software object is a collection of related finctions (or intelligence) and the functions' (or intelligence's) associated state.

A COM provides a means to address problems of application complexity and evolution of functionality over time. It is a widely available, powerful mechanism for customers to adopt and adapt to a new style multi-vendor distributed computing, while minimizing new software investment. COM is an open standard, fully and completely publicly documented from the lowest levels of its protocols to the highest. As a robust, efficient and workable component architecture it has been proven in the marketplace as the foundation of diverse and several application areas including compound documents, programming widgets, 3D engineering graphics, stock market data transfer, high performance transaction processing, and the like.

COM is not a prescribed way to structure an application; rather, it is a set of technologies for building robust groups of services in both systems and applications such that the services and the clients of those services can evolve over time. In this way, COM is a technology that makes the programming, use, and allows development of uncoordinated or independent evolution of binary objects. COM provides a ready base for extensions oriented towards increased ease-of-use, as well as a great basis for powerful, easy development environments, language-specific improvements to provide better language integration, and pre-packaged functionality within the context of application frameworks.

COM defines a completely standardized mechanism for creating objects and for clients and objects to communicate. Unlike traditional object-oriented programming environments, these mechanisms are independent of the applications that use object services and of the programming languages used to create the objects. The mechanisms also support object invocations across the network. COM therefore defines a binary interoperability standard rather than a language-based interoperability standard on any given operating system and hardware platform. In the domain of network computing, COM defines a standard architecture-independent wire format and protocol for interaction between objects on heterogeneous platforms. This binary interoperability standard allows the COM object to perform its functions across even a mixed operating system network environment.

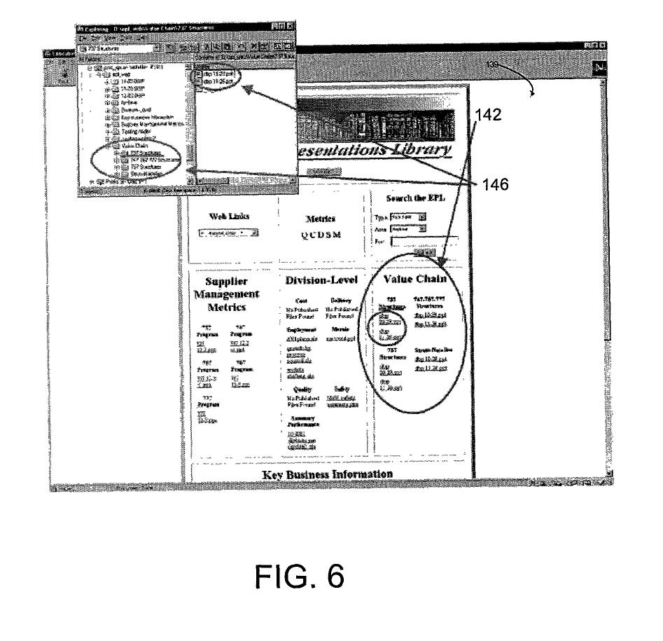

Logging-in and receiving security privileges activates the COM object that dynamically generates a page 139 displayed in FIG. 6. The COM object reads the files located in a location determined according to the log-in, and creates a hyperlink for each of the files at the location. It is envisioned that collaborators will not correspond necessarily on a one to one basis with projects and an intermediate screen might be appropriate to allow the user or collaborator to additionally submit information that might determine the location of the relevant files. FIG. 6 presumes the determination of the location has occurred and the COM object operates on the files and directories found at that location. Where the discrete files and directories available to the COM object are determined, the COM object queries a MIME type for each and generates a Web page including the locations of each file. SMTP has been extended so that network clients and server could recognize and handle other kinds of data than ASCII text. As a result, new file types were added to “mail” as a supported Internet Protocol file type.

Servers insert the MIME header at the beginning of any Web transmission. Clients use this header to select an appropriate “player” application for the type of data the header indicates. Some of these players are built into the Web client or browser (for example, all browser come with GIF and JPEG image players as well as the ability to handle HTML files); other players may need to be downloaded. The COM object performs this inquiry as a server might and sends incorporates that information in the dynamically drawn Web page 139 as shown in FIG. 6.

FIG. 6 displays the deployment of the information on a HTML page. A directory structure 146 of the files and directories at the location specified in the log-in procedure are displayed in the Windows Explorer™ interface suitably to display the structure 146. The COM object displays such a structure with the “nested” page structure 142. Nesting is not necessary for the invention but is a preferred embodiment of the invention. Nesting demonstrates the viability of dynamic page generation.

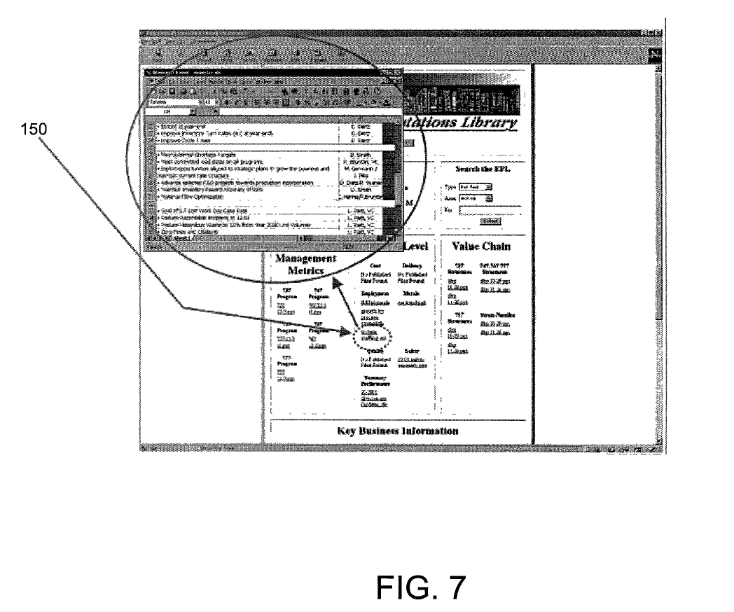

The culmination of the work of the COM object within the invention occurs, as shown in FIG. 7, when the COM object generates and sends the Web page to the user's browser. Deployed within the written page are links 150 to data files. “Clicking on” the link 150 deploys either a viewer plug-in within the browser or an application properly associated with the data. At the browser, the page is interpreted with the MIME information. To the same extent that it might for other pages, the browser is then able to present the file to the user's application for use according to the security privileges accorded above.

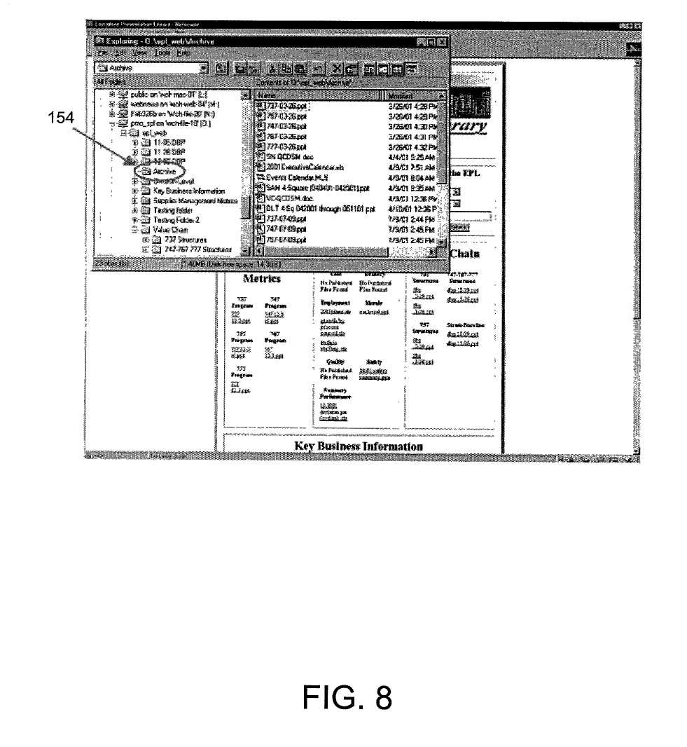

One advantage of the invention is the dynamic nature of page generation. As shown in FIG. 8, an author seeking to publish a document or file need only place that file in the appropriate directory. Either adding or removing a file will automatically change the page that the COM object dynamically generates. To receive a link in the dynamically generated page, the file must be present at the designated directory. Once removed, the COM object will not generate a link to the missing file, thereby eliminating the opportunity for the user to experience what is commonly known as a “404 error”. “404 errors” can be a substantial source of frustration for the user, and may discourage the user from using the information technology. A distinct directory or archive 154 is used to store the outdated file, at the author's option.

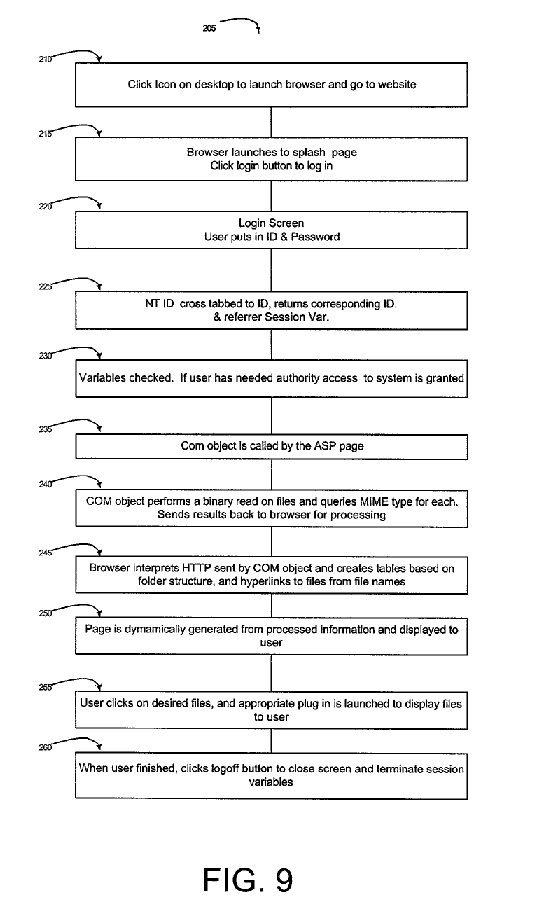

FIG. 9 shows a method 205 according to the present invention. At block 210, the user invokes the browser by clicking on an icon on the user's desktop. The act of clicking on the icon also directs the browser to the address of a splash page. At block 215, the browser launches thus displaying the splash page. The user then clicks on a graphic object on the splash screen. The graphic object redirects the browser to the log-in screen.

At block 220, the user logs-in, supplying an ASP with the information necessary to identify the user. At block 225, the invention compares the log-in information with that on a look-up table and grants privileges accordingly at block 230. The identity will also determine the location of the pertinent files. When complete at block 235, the ASP will invoke a COM object for generation of a Web page.

At block 240, the COM object performs a binary read on the files at the location specified. In that read, the COM object determines the MIME type of the files there at block 245. Having garnered information from the read, the COM object creates tables based upon the directory structure and base upon that information, generates the appropriate page at block 250. The COM object sends this generated page to the browser for display for the user.

At block 255, the user clicks on desired files, and according to the plug-ins installed with the browser, the contents of the file are displayed to the user. After reviewing, and if extended such privileges modifying the contents of the files, the user logs-off at block 260.

While the preferred embodiment of the invention has been illustrated and described, as noted above, many changes can be made without departing from the spirit and scope of the invention. For example, the COM object can generate pages according to a stored template or ASP file. Such a template might include graphics indicative of the source of the files. Accordingly, the scope of the invention is not limited by the disclosure of the preferred embodiment. Instead, the invention should be determined entirely by reference to the claims that follow.

What is claimed is:

1. A method for publishing data on a network comprising:
launching a web browsing software program;
directing the web browsing software program to a first address on the network;
retrieving a first set of data located at the first address;
invoking a COM object program associated with the first set of data;
employing the COM object to identify a second set of data located at a second address stored in association with the first address on the network;
translating the second set of data to a format interpretable by the web browsing software program; and
displaying the formatted second set of data.

2. The method of claim 1, wherein invoking the COM object program includes logging-in to the COM object.

3. The method of claim 1, wherein the employing the COM object program includes:
reading the second set of data;
categorizing the second set of data according to a MIME identity of the second set of data; and
invoking associated software programs to interpret the second set of data.

4. The method of claim 1, wherein the translating of the second formatted set of data includes constructing a representation of the second set of data to include a directory indicative of a list of contained files.

5. The method of claim 4, wherein displaying the formatted second set of data includes:
enabling links to the contained files within the second set of data, and
displaying the enabled links within the formatted second set of data.

6. The method of claim 5, wherein the directory is a web page.

7. A software product for displaying within a browser a first set of data as a web page, the software product comprising:
executable first data located at a first addressable memory site within a network, the executable data including:
first program code means for executing the first executable data upon being downloaded by the browser from the first addressable memory site; and
second program code means for recognizing MIME attributes of second data at a second addressable memory site within the network; and
a page writer to construct a web page representing the second data, the page writer including:
links to direct the browser to download the second data; and
commands to launch software associated with the MIME attributes of the second data.

8. The software product of claim 7, wherein the executable first data includes a login script to identify a user of the browser.

9. The software product of claim 8, wherein the login script includes a script to select an addressable memory site from a plurality of the second addressable memory sites according to the identity of the user.

10. The software product of claim 8 wherein the login script includes a script to accord privileges to the user according to the identity of the user to change the second data.

11. A system for automatically generating a web page for display:
a network of computers, including at least one server and a plurality of client computers;
a first addressable memory site within the network;
executable first data located at the first addressable memory site within the network, the executable first data including:
first program code means for executing the first executable data upon being downloaded by a browser from the first addressable memory site; and
second program code means for recognizing MIME attributes of second data at a second addressable memory site within the network; and
a page writer to construct a web page representing the second data, the page writer including:
links to direct the browser to download the second data; and
commands to launch software associated with the MIME attributes of the second data.

12. The system of claim 10, wherein the executable first data includes a login script to identify a user of the browser.

13. The system of claim 8, wherein the login script includes a script to select an addressable memory site from a plurality of the second addressable memory sites according to the identity of the user.

14. The system of claim 8 wherein the login script includes a script to accord privileges to the user according to the identity of the user to change the second data.
